(19) United States
(12) Patent Application Publication
(10) Pub. No.: US 2006/0154084 A1
(43) Pub. Date: Jul. 13, 2006

(54) Production of metal glass in bulk form

(75) Inventors: Christopher A. Schuh, Ashland, MA (US); Andrew J. Detor, Somerville, MA (US)

Correspondence Address: STEVEN J WEISSBURG, 238 MAIN STREET, SUITE 303, CAMBRIDGE, MA, 02142, US

(73) Assignee: Massachusetts Institute of Technology, Cambridge, MA (US)

(21) Appl. No.: 11/032,680

(22) Filed: Jan. 10, 2005

(51) Int. Cl. B32B 15/04; C25D 5/00; C25D 3/66; B32B 17/06

(52) U.S. Cl. 428/426; 428/432; 428/469; 205/80; 205/230

(57) ABSTRACT

A method for fabricating metal glasses in bulk form uses electrodeposition. Careful control is maintained of: (i) bath chemistry, (ii) deposition temperature; and (iii) electrical plating conditions, such as the current density, for an extended period of time, such as six hours. Composition of electrodeposition liquid is closely controlled, and adjusted when it differs from desired. Monitoring can be active, as by spectrophotometric analysis, or by comparison of time to a calibration table. A dissolving anode can replenish depleted components. Temperature of the liquid is typically maintained within ±2° C. Object composition can be, but is not limited to: Nickel (Ni) and Tungsten (W); Iron (Fe) and Molybdenum (Mo); Iron (Fe) and Tungsten (W); Nickel (Ni) and Molybdenum (Mo); Nickel (Ni) and Phosphorous (P); Nickel (Ni), Tungsten (W) and Boron (B); Iron (Fe), Nickel (Ni) and Carbon (C); Iron (Fe), Chromium (Cr), Phosphorous (P) and Carbon (C); Cobalt (Co) and Tungsten (W); Chromium (Cr) and Phosphorous (P); Copper (Cu) and Silver (Ag); Copper (Cu) and Zinc (Zn); Cobalt (Co) and Zinc (Zn). Metal glass bulk objects can be electroformed from elements that can not be cast, either due to excessively high melting temperatures, or less than perfect miscibility. Metal glass objects can be unitary, or may include a core of another material. Electrodeposition liquid may be aqueous, alcohol, hydrogen chloride, or metal salt. Useful metal glass objects include but are not limited to at least a portion of: a golf club head; a racquet head, for instance a tennis or squash racquet head; a snowboard; a ski edge; knife blade cutting edge; and many different types of springs.

### GOVERNMENT RIGHTS

The United States Government has certain rights in this invention pursuant to the U.S. Army Research Office contract/grant #DAAD19-03-1-0235.

A partial summary is provided below, preceding the claims.

The inventions disclosed herein will be understood with regard to the following description, appended claims and accompanying drawings, where:

### BRIEF DESCRIPTION OF THE DRAWINGS

FIG. 1, is a schematic representation of a Ni—W metal glass object having bulk dimensions of 1.18 mm×20 mm×50 mm;

FIG. 2 is a schematic in block diagram form, showing a typical hardware set-up for practicing an embodiment of a method of an invention hereof, showing a bath reservoir, power supply, cathode, anode and temperature control components;

FIG. 3 is a graphical representation showing Tungsten (W) composition of a deposit as a function of bath temperature, for otherwise constant experimental conditions (current density of 0.2 A/cm², bath composition as in Table 1, and pH of ˜8.0);

FIG. 4 is a graphical representation of X-ray diffraction patterns of bulk electrodeposits with tungsten compositions of 24, 16, 6, and 4 atomic percent (at %), from the lowest to the uppermost traces; and

FIG. 5 is a schematic representation in flow chart form of a method embodiment of an invention hereof, for fabricating a bulk dimension metal glass object by electrodeposition.

### DETAILED DESCRIPTION

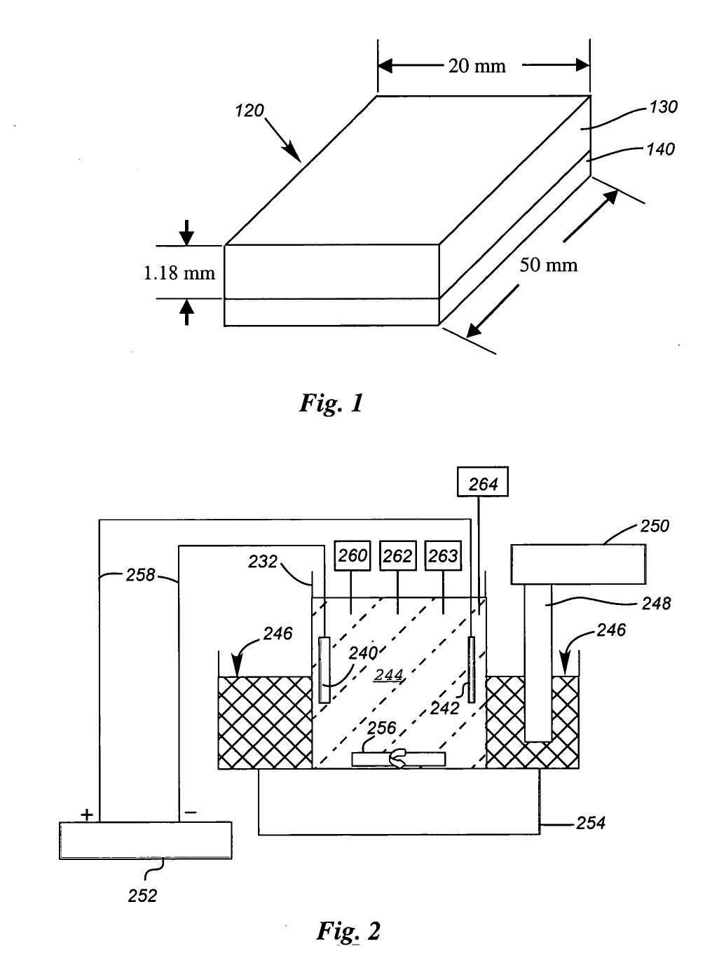

Metallic glasses, which are also known as amorphous metals and non-crystalline metals, offer a combination of exceptional properties making them desirable for a variety of applications. Unlike most metals and alloys, these materials lack any long range structural order at the atomic level, i.e., they are non-crystalline. As a consequence of their lack of long range structure, metal glasses exhibit significantly higher yield strengths, wear resistance, and corrosion resistance, among other important properties, as compared to their typical crystalline metals. Between about 1993 and 2004, much research and industrial development effort has gone into the formation of so-called bulk amorphous metals. The term bulk, typically as used herein, means a specimen that is larger than 1 mm in three orthogonal directions, such as is shown in FIG. 1, which is a schematic of a Ni—W metal glass object having bulk dimensions of 1.18 mm×20 mm×50 mm.

Bulk forms of metal glass are useful for a variety of applications, as is discussed further on. To date, the effort in bulk metallic glass formation has been overwhelmingly focused on casting of alloys from the molten metal state.

In casting, a highly constrained alloy composition is rapidly quenched from the molten state, under circumstances that avoid any crystallization event. The most common commercialized cast alloy is composed of five elements (zirconium, beryllium, titanium, copper, and nickel), making its production complex and expensive. In fact, all cast metal glass alloys are complex and have multiple components. Small variations in composition can lead to undesirable crystalline castings rather than amorphous glass ones, and the composition requirements are still not well understood. In casting, the geometry is fixed by a mold shape, and often requires subsequent forming processes for certain types of shapes that cannot be molded directly. Casting requires high temperature processing, on the order of 1500° C. or higher, which has significant energy costs and costs associated with making a high temperature working environment acceptably safe. Certain metals, such as tungsten (W) and molybdenum (Mo) have extremely high (greater than 2,500° C. melting temperatures. Casting is further limited to those combinations of metals and elements that are miscible. For instance, tungsten is not perfectly miscible with any element of the iron group (iron (Fe), cobalt (Co), and nickel (Ni)) and thus, metal glasses with any immiscible combinations can not be cast under routine circumstances. Similarly, neither molybdenum (Mo) nor phosphorous (P) are perfectly miscible with any element of the iron group.

### Objects

Thus, there is need for a method to produce bulk metal glasses with as few as two elements (for instance, Ni and W), and over a relatively broad composition range of those, or other elements. Further, there is need for a method that offers new possibilities for producing complex metal glass shapes that would otherwise require multiple casting and shape forming operations. There is also need for a low (or lower) temperature metal glass fabricating process that has lower energy costs than does casting methods, and also that can be accomplished in a safer manufacturing environment than is required for casting. Further, there is a need to produce bulk metal glasses from combinations of metal and elements that exhibit immiscibility.

An invention hereof is a new method for fabricating metal glasses in bulk form, using electrodeposition. Electrodeposition can provide a more diverse, flexible, and, in some cases, economically favorable production of bulk metal glasses than can casting. Other inventions hereof include bulk metal glass items made according to the method, particularly having shapes that are not castable, or that are difficult to cast. Additional inventions hereof are apparatus for practicing method inventions hereof.

In electrodeposition, a potential is applied across an anode and a cathode placed in a solution containing metallic ions. Under the influence of the electric field, positive metal ions are attracted to and deposited on the cathode, initially on its surface and thereafter, upon previous deposited metal. After discharging at the cathode, metal atoms arrange into a thermodynamically stable or metastable state. Various techniques have been developed and are disclosed to tailor the microstructure of electrodeposited metals to be non-crystalline, by limiting the states that the system can access.

An invention that is disclosed herein is a process of forming metal alloys with a non-crystalline structure and bulk dimensions by electrodeposition, with careful control of the: (i) bath chemistry, (ii) deposition temperature, and (iii) electrical plating conditions. These requirements are discussed more fully below.

A basic hardware set-up that can be used for practicing a method of an invention hereof is shown schematically in block diagram form in FIG. 2. A vessel 232 contains a liquid 244, such as an electrolyte bath, in which are found the components that will form the metal glass, such as metal ions. A cathode 240 and an anode 242 are immersed in the liquid 244, and are coupled through conductors 258 to a power supply 252. A magnetic stirrer 254, has a moving part 256 that is within the vessel 232. An oil bath 246 surrounds the bath vessel 232. A heater 248 is immersed in the oil bath 246, and is controlled by a thermal controller 250. The power supply 252, thermal controller 250 and magnetic stirrer 254 may all be controlled by a single computerized controller, which is not shown, or by individual controllers that are governed by a human operator. A temperature sensor 260 measures the temperature of the liquid 244. A bath composition monitor 262 monitors the composition of the bath with respect to important components, such as the two materials that make up the glass, complexing agents, discussed below, etc. A suitable composition monitor is a spectro-photometer another parameter sensor 263, which may be a set of several sensors, measures other parameters, such as pH (measured by a pH meter) and viscosity (measured by a rheometer).

A composition adjustment module 264 is controlled by a composition controller (not shown), which takes as inputs the output from the composition monitor 262, and the temperature sensor 260 and the parameter sensor 263, and generates commands to the composition adjustment module 264 to dispense into the bath a specific amount of a material, or materials.

In operation, a potential difference is applied by the power supply between the anode and the cathode. This difference causes ions in the liquid to be drawn toward the cathode 240, upon which they are deposited. If the conditions are controlled properly, the deposit can be maintained in an amorphous state, such that it is non-crystalline.

In the most general case, deposition of a bulk metallic glass requires several things. An electrodeposition system must codeposit two or more elements simultaneously, at least one of which being a metallic element. Single metal systems cannot typically be made to be amorphous, as they tend very quickly to become structured. Not only must proper glass forming elements be chosen, but they must be present in ratios that will allow metal glass to form. Plating conditions must be carefully chosen so that a specific glass-forming composition alloy is produced. The plating conditions must be extremely stable, to ensure that the composition of the depositing metal does not drift. Specifically, the bath chemistry and bath temperature must be monitored and regulated for long periods of time to produce 1 mm or thicker deposits that do not vary from a specified glass forming composition. Specific examples of time required for an item of a particular size are provided below. But in general, conditions must be kept regular for at least six hours.

In addition to satisfying the foregoing conditions, the plating parameters must be chosen to avoid: (i) stresses that promote cracking, etc.; and (ii) formation of extensive voids that compromise the integrity of the deposit. For example in a Ni—W system, a temperature that is too low, or a current density that is too high, can promote void formation.

Furthermore, the cathode must be of a geometry that is suitable as an electroforming progenitor shape for the geometry of the finished object. Thus, it must be one which, after layer upon layer of metal glass are formed, the body assumes the shape of the finished object. Moreover, if the finished object is to be one which is wholly metal glass, then the shape of the cathode must be one which, after serving as the progenitor shape for electroforming the finished object, can then be removed, for instance by either mechanical or chemical processes.

The foregoing description of the hardware shown in FIG. 2 describes element 262 as a composition sensor, such as a spectrophotometer, which measures a property of the liquid in relative real time. Other types of composition sensors can be used. For instance, in advance, a process can be calibrated, by running it for a period of time, and then measuring the composition of the bath by any suitable means, including those that can be performed as the process continues such as spectro-photometry, or those that require stopping the process, such as removing all of the liquid and analyzing it in a batch. This is done for several time durations, so that the process is calibrated for given conditions. Thus, a suitable composition module could be a clock that measures time, coupled to a calibration table in some manner, for instance through a human operator or an automated machine, such as a programmed computer.

Another method combines the functions of a composition monitor 262 and a composition adjustment module 264 into a simple element, by using a dissolvable anode, such as is used in the nickel plating industry. Such an anode dissolves away at a rate appropriate to maintain the bath composition within a chosen range. One or more such anodes can be used, in parallel.

An embodiment of an invention is a method for forming bulk specimens of Ni—W (Nickel-Tungsten) metal glass. The plating bath includes metal salts of Ni and W. The bath also includes complexing agents to control the co-deposition of Ni and W, as discussed below. Various researchers have studied the effects of bath composition on the quality and composition of the resulting deposits for deposits of thin films.

In a bath designed to deposit a metal alloy of more than one metal, there is the added difficulty that if the reduction potentials of the ions to be deposited are not close enough to one another, approximately +/−0.1 volt, then the more noble metal (the metal having a higher reduction potential) will be deposited preferentially. The result would be essentially a single-metal deposit. It is possible to manage the reduction potentials by varying the relative concentration of metal ions in the bath, but this method is only practical for metals with reduction potentials that are relatively close to one another from the start (e.g. within 0.5 volts).

A different method to deposit metal alloys has been used with thin, non-bulk dimension formations. It is to use what are known as complexing agents in the bath. A complexing agent is an ion or molecule to which one or more free metallic ions are attached. By using complexing agents, two or more metal ions can be co-deposited, meaning that they are deposited together. For example, suitable complexing agents for use in a Ni—W (Nickel-Tungsten) bath are sodium citrate, and ammonium chloride. Both have been used together for production of thin film metal glass. Ammonium chloride is used in general, to increase the rate of nickel deposition. The citrate ion forms a complex with both Ni and W so that, when this citrate-Ni—W complex is attracted to the cathode, the Ni and W ions are reduced at the surface together to form the alloy. It has been determined that such complexing agents can be used to form bulk metal glasses also.

The bath composition (in molarity) used in one example of an embodiment of an invention hereof is given in Table 1. The anode 242 was Pt platinum, and the cathode 240 was commercial purity copper, polished to a mirror finish. The cathode 240 may also be considered a substrate, because the deposited metal takes its shape from the cathode. In some embodiments, the cathode is removed from the formed metal glass after formation, such as by etching, machining, or other mechanical processes.

TABLE 1
Bath composition used for Ni—W deposition.

| | | |
|---|---|---|
| Nickel Sulfate Hexahydrate (NiSO₄.6H₂O) | 0.06 | M |
| Sodium Tungstate Dihydrate (Na₂WO₄.2H₂O) | 0.14 | M |
| Sodium Citrate Dihydrate (Na₃C₆H₅O₇.2H₂O) | 0.5 | M |
| Ammonium Chloride (NH₄Cl) | 0.5 | M |
| Sodium Bromide (NaBr) | 0.15 | M |

To ensure high quality deposits with uniform composition, the bath composition must be actively maintained, as metallic ions are depleted from the bath during deposition. This is very important for the deposition of bulk materials with thickness greater than 1 mm because such a significant quantity of material is withdrawn from the bath to constitute the formed body. Thus, part of a present invention hereof involves careful control and active replenishment of the bath composition during the plating process. Complexing agent concentration need not be monitored because it is not depleted from the bath.

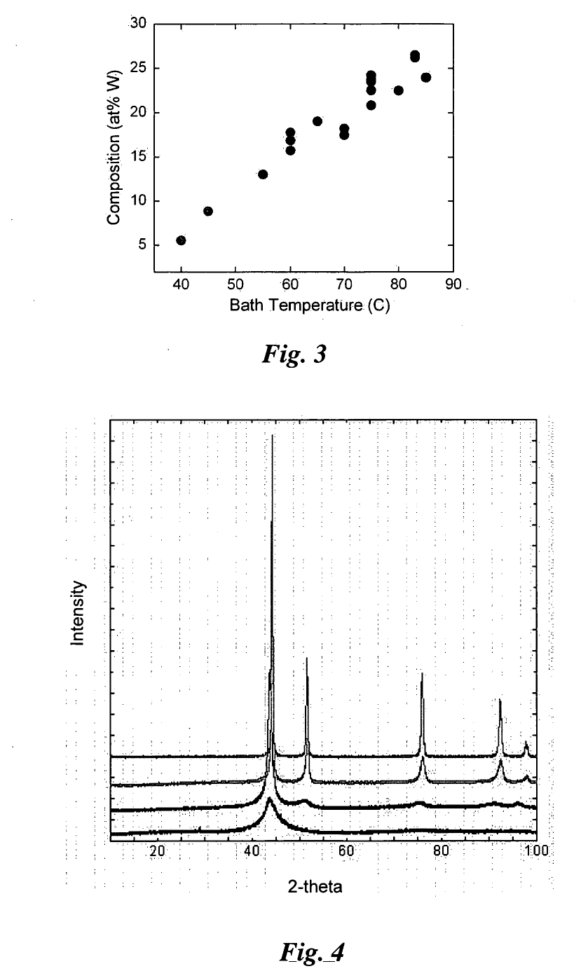

In addition, the temperature of the plating bath is an important variable in controlling the composition of the resulting deposit. FIG. 3 shows that a variation of a few degrees (° C.) has a significant effect on the composition. For instance, at 65° C., the W at % is about 21, while at 67° C. it is about 23% and at 84° C. it is about 26%.

For example, for a Ni—W system, temperature control within +2° C. is preferred. For different systems, the acceptable tolerance will differ. Also, the temperature tolerance will depend upon the nominal operating set point.

The temperature required to form a metal glass deposit differs from system to system, and, within any one system, the temperature can differ from one bath composition to another. For example, Fe—Co—P can be deposited as a metal glass at 50° C. Ni—Mo can be deposited in metal glass form at room temperature (˜24° C.), as can Ni—W, albeit at a different bath composition than discussed above. Ni—Co—P can be deposited in metal glass form at 80° C.

Tight tolerance on the composition is necessary as this in turn dictates the microstructure of the deposit, as illustrated by FIG. 4. FIG. 4 shows schematically the relation between x-ray diffraction intensity on a vertical scale and the diffraction angle 2-theta on a horizontal scale, for four different compositions of deposit, having 4, 6, 16 and 24 at % tungsten (W) as shown from the upper to the lower traces. For instance, when the tungsten (W) content of the deposit drops below ˜22 at %, as represented by the three upper traces, the structure is likely to be crystalline rather than amorphous. The x-ray diffraction patterns in FIG. 4 demonstrate this result, with the ˜24 at % W alloy (lowest trace) exhibiting a broad single peak characteristic of an amorphous structure, while alloys of lower W content (the upper three traces) exhibit the pattern of multiple peaks, indicative of crystallinity.

Therefore, to produce a bulk metal glass alloy requires not only careful control of the bath chemistry, but also precise control of bath temperature to ensure a amorphous non-crystalline glass structure throughout the entire thickness.

By following the above protocols, bulk metal glass Ni—W specimens have been made, using the bath chemistry from Table 1. Bath chemistry was controlled by careful prior calibration of the bath composition relative to time, measurement of passing time, and periodic (roughly hourly) refreshment of the composition, while a steady temperature (+/−2° C.) was maintained with a large oil bath 246, controlled by a digital temperature controller 250. The computer controlled heater is available from VWR International model 371 of West Chester, Pa. A suitable power supply is available from Dynatronix of Amery, WE, model PDR-40-50-100. A suitable magnetic stirrer, model No. 371 is also available from VWR International.

In general, high quality Ni—W metal glass can be formed using the above bath composition within +/−0.1M, and an average current density of between 0.18 and 0.22 A/cm². The temperature can be between 75 and 80° C.

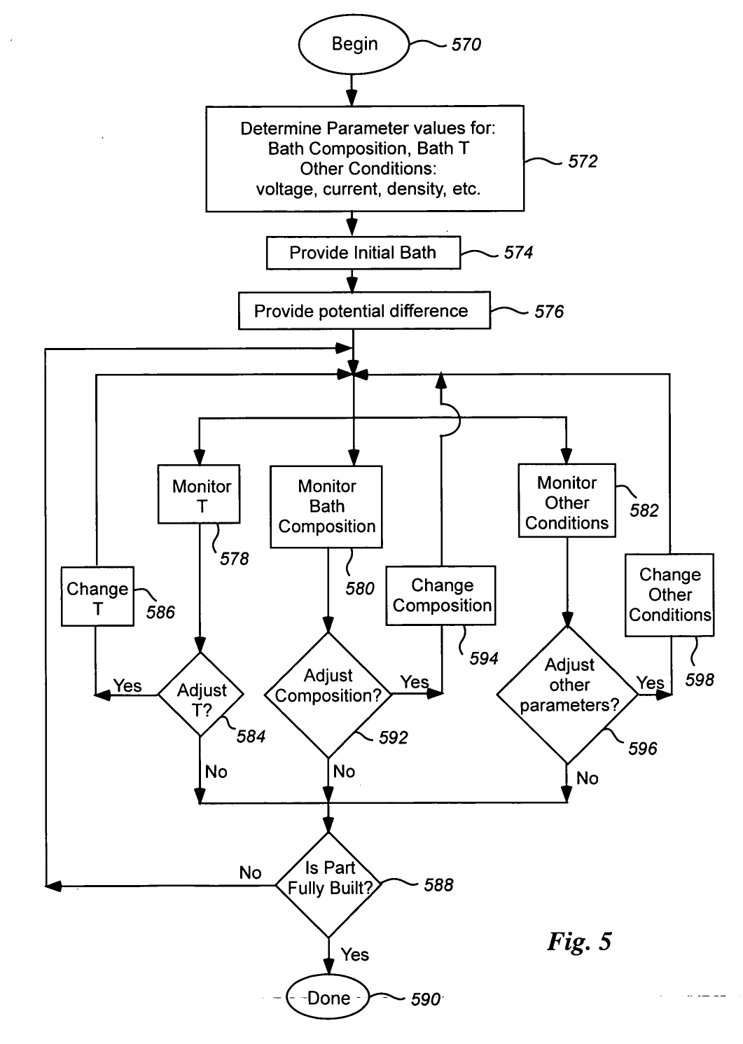

An embodiment of a method to create a bulk amorphous body is shown schematically in flow chart form in FIG. 5. The process begins 570 and values are determined 572 for important parameters such as bath composition (components and their concentrations), bath temperature, and other conditions, such as current density, ph, etc. An initial bath is provided 574 with the values for the parameters as determined. A potential difference is provided 576 between the cathode and the anode, current flows, and plating begins. Several different types of monitoring take place essentially in parallel, although measurements of different parameters need not be taken simultaneously. Temperature is monitored 578. Bath composition is monitored 580 and other conditions are monitored 582.

Taking first the consideration of temperature, the output of the temperature monitoring step is considered and it is determined 584 whether it is necessary to adjust the temperature or not. If so, the temperature is changed 586 by some suitable means, for instance using the oil bath and heating or cooling that. If the temperature need not be adjusted, the method continues to another decision step where it is considered 588 whether the part has been fully built. If so, the process is done 590. If not, the process returns to the steps of monitoring temperature 578, bath composition 580, other parameters 582 and then proceeds as before to adjust each one, or not, as the case may be.

Turning now to the consideration of composition, which occurs in parallel with the consideration of temperature and other parameters, it is determined 592 whether it is necessary to adjust composition or not. If not, then the process continues on to consider 588 if the part has been fully built, as discussed above. If adjustment of composition is necessary, then the process turns to a change composition step 594, in which the composition is adjusted as necessary. The process then returns to the steps of monitoring as discussed above. As has been discussed above, determining whether it is necessary to adjust composition can be done by a prior calibration of bath composition over time, coupled with measuring time. Or, it can be accomplished by real time composition measurement, such as with a spectrophotometer or other suitable device. Or, a combination of the two methods can be used, with coarse adjustments being made with reference to time and a calibration table, and finer, adjustments being made less frequently by real time measurement, followed by introducing new material, if need be. Finally, as mentioned, for some systems, a dissolving anode can be used, which dissolves at a regular rate and therefore, essentially monitors and adjusts the composition, in situ.

Other conditions, such as current, density, voltage, viscosity etc., are considered 596, and, if it is determined that no change is necessary, the process continues to determine 588 whether the part is fully built. If any condition need be adjusted, then the process makes such an adjustment 598 to the necessary condition, and returns to the monitoring stage. There can be more than the illustrated conditions that are evaluated and adjusted.

When it is determined 588 that the part is fully built, then no adjustments are made, the voltage is removed, plating ceases, and the process is done 590.

Using an applied current density of 0.2 A/cm², the specimen shown schematically in FIG. 1 was produced in thirty hours. This specimen was verified as non-crystalline by x-ray diffraction, as shown by the lower trace shown in FIG. 3 (24 at % W). Additionally, the thickness of this specimen was variable, ranging from 1 to 1.6 mm, although that variation was primarily due to an edge effect, where material was drawn preferentially to an edge of the electrode. The substrate region 140 is copper, and the deposited Ni—W region 130 is above.

This specimen exhibited a very high hardness of about 7.0 GPa. This hardness value exceeds that of plain carbon steel and most stainless steels, and is roughly equivalent to the highest values possible in quenched martensitic alloy steels.

Turning attention now to a discussion of some of the advantages, of inventions hereof, bulk metal glasses can be produced by electrodeposition with as few as two elements (for instance, Ni and W), and over a relatively broad composition range. Further, scaling up electrodeposition to industrial capacity would be relatively straightforward. With a large enough bath, anode surface area, and power supply, any size cathode can be used to plate out metal glass. Existing technologies are already in place to handle large dimension plating operations for crystalline coating technologies and these could be adapted to produce large sheets of metal glass by straightforward variations.

Another advantage is that with electrodeposition, the geometry of the substrate dictates the shape of the deposited bulk metal, whereas in casting, the geometry is dictated by the mold shape, and often requires subsequent forming processes. Therefore, electrodeposition offers new possibilities for the production of complex shapes that would otherwise require multiple casting and shape forming operations. The cathode material may be later removed, to form wholly amorphous product, or, it may remain as a substrate that is coated with metal glass material in one or more regions, including over its entire extent. Further, a mask or masks can be used to coat only one part of the cathode, or to coat one part with one material, a second part with another material, etc, using general masking techniques, using masks with different geometries.

Electrodepositing bulk metal glass enables fabricating some combinations of metal that cannot be cast, conveniently, due to excessively high melting temperature (e.g. including tungsten (W) or molybdenum (Mo), or at all, including immiscible metals, (e.g., neither tungsten, molybdenum nor phosphorous is perfectly miscible with any of the iron group, including iron, cobalt or nickel. But, liquid solutions having compositions including these elements can exist, and by electrodeposition, bulk metal glass bodies can be made.

Cobalt and molybdenum also can form a useful metal glass by electrodeposition.

Finally, with electrodepositing bulk metal glass, high temperature processing required for casting is avoided, leading to reduced energy costs and a safer, lower temperature working environment. For instance, typical maximum temperatures required for electrodeposition techniques are approximately 95° C. Typical casting temperatures are metal dependant, often exceeding 1500° C., for instance, for castings that contain iron.

Turning next to a discussion of some commercial applications, metal glasses can present attractive alternatives for a broad range of products, a few of which are described below.

Due to their high yield strength, metal glasses have already been marketed in sporting goods applications where efficient energy transfer is required (i.e. as golf club heads or tennis racquet frames). Such products have been formed by casting. The cost, however, of casting metal glass golf club heads has proven challenging for large scale commercial development. Electrodeposition could benefit this area by allowing application of a bulk metal glass layer of more than 1 mm thick, around a substrate of traditional golf club head material, providing performance equivalent to that of a fully metal glass head, at a fraction of the cost. Other areas where efficient energy transfer is important, such as springs for suspensions, would also benefit from the processing capability of electrodeposition over that of casting.

High yield strength makes metal glass attractive where it is desirable to maintain a sharp edge (e.g. knife and tool blades, ski edges, razor blades, etc.). In many of these applications, electrodeposition can produce either the entire product as fully metal glass, or a thick metal glass layer on a traditional metallic or other substrate, whichever route offers the best combination of properties for the specific application.

The generally high corrosion resistance of metal glasses makes them attractive for application in harsh environments. Fully thick metal glass pipes can be produced by electrodeposition and used in the chemical processing industry or in nuclear power plants where the transport of highly corrosive material is necessary. Other, less critical applications where the property of corrosion resistance is important, include casings for electronic or other components, and decorative finishes.

In summary, the high energy transfer efficiency, yield strength, and corrosion resistance of metal glasses will be of benefit in many applications. Adding the flexibility and efficiency of an electrodeposition process will surely extend the markets into which bulk metal glass can be applied.

### Variations

While the foregoing has discussed a specific binary system for Ni—W, including bath chemistry and plating parameters, the extents of present inventions hereof are not limited in this respect. Multiple bath chemistry variations and plating parameters can be used to electrodeposit binary amorphous Ni—W alloys.

One variation is to replace ammonium sulfate with glycine. Combinations of brighteners, wetting, or stress relief agents can be used such as: Saccharin; Boric Acid; 2-butyne-1,4-diol.

A pulsed current waveform can be used for additional control of alloy quality, such as crack and defect content, as well as surface levelness, in a similar manner as has been found to be useful for thin film metal glass deposits.

Inventions hereof also include other metal systems that can be electrodeposited in a non-crystalline state. These systems need not be binary alloys, but also can be ternary and higher combinations of elements. Significant literature exists discussing non-bulk (thin film or other small dimension structure) glassy metals that are electrodeposited from aqueous solutions. It is believed that techniques of inventions hereof can also be applied to such systems, including but not limited to: nickel-molybdenum (Ni—Mo); nickel-phosphorous (Ni—P); nickel-tungsten-boron (Ni—W—B); iron-molybdenum (Fe—Mo); cobalt-molybdenum (Co—Mo); iron-tungsten (Fe—W); iron-nickel-carbon (Fe—Ni—C); iron-chromium-phosphorous-carbon (Fe—Cr—P—C); iron-chromium-phosphorous-Nickel-Carbon (Fe—Cr—P—Ni—C); copper-silver (Cu—Ag); copper-zinc (Cu—Zn); cobalt-nickel-phosphorous (Co—Ni—P); cobalt-tungsten (Co—W) and chromium-phosphorous (Cr—P). Other systems that can provide at least two metal salts in aqueous solutions are also possible. Other types of solutions, are possible, including but not limited to: non-aqueous, alcohol, HCl (liquid hydrogen chloride), and molten salt.

If a molten salt bath is used, the operating temperature may be higher than for an aqueous bath, but it would still be much cooler than for a metal casting process.

The liquid has been generally referred to above as a bath. The liquid need not be a stationary body of liquid in a closed vessel. The liquid can be flowing, such as through a conduit, or streaming through an atmosphere. All of the discussions above regarding a bath can also apply to such a moving liquid composition.

By employing careful controls, such as described here, bulk metal glass alloys in these systems are possible by electrodeposition.

### Partial Summary

Inventions disclosed and described herein include methods of making metal glass bulk objects, bulk metal glass objects themselves, and metal glass bulk objects made according to disclosed methods.

Thus, this document discloses many related inventions.

One invention disclosed herein is a method for fabricating a metal glass object having bulk dimensions, comprising the steps of: providing an apparatus comprising an anode and a cathode, coupled to each other through a power supply; and providing, in contact with the anode and the cathode, a liquid comprising at least two ions, at least one of which is a metallic ion, the liquid being a specific composition that promotes formation of a metal glass body. The method also includes the steps of: providing an electric potential between the cathode and the anode such that at least two elements plate out of the liquid at the cathode, at least one of which elements is a metal, to form metal glass at the cathode; and maintaining conditions sufficiently regular for a sufficiently long time so that the elements continue to plate at the cathode as a metal glass until a body is formed that has at least bulk size in three orthogonal directions.

In a related embodiment the object may have a useful shaped geometry. The cathode may then be of metal and of a shape suitable as a progenitor shape for a finished object having the useful shaped geometry. With such an embodiment, conditions are further maintained sufficiently regular for a sufficiently long time so that the elements continue to plate at the cathode as a metal glass until a body is formed that has a metal glass covering over the cathode, which covering is at least bulk size in three orthogonal directions and which body has the useful shaped geometry. Such a method may further comprise the step of removing at least a portion of the cathode after a body is formed that has at least bulk size in three orthogonal directions. Or, all of the cathode may remain as part of the finished object.

According to still another embodiment of a method, the step of providing an apparatus further comprising providing a vessel, and the step of providing a liquid may comprise providing a liquid in the vessel, in which the anode and the cathode also reside.

In another related embodiment, the liquid comprises an aqueous solution.

Or, for a different embodiment, the liquid may comprise at least one molten salt

With still another related embodiment, the liquid comprises at least one metal salt.

For yet another different embodiment, the liquid may comprise alcohol.

By even another embodiment the liquid may comprise liquid hydrogen chloride (HCL).

In one embodiment, the step of maintaining conditions comprises maintaining the composition of the liquid sufficiently constant. Other embodiments comprise maintaining the temperature of the liquid sufficiently constant or the electrical conditions sufficiently regular. For instance, it is sometimes useful to maintain the temperature within 2 degrees Centigrade above and below a temperature set point. Temperature may be maintained using a digitally controlled oil bath in thermal communication with the liquid and using the oil bath to control the temperature of the liquid. Electrical conditions may be maintained by maintaining the current density with a regular amplitude pulse.

With several additional preferred embodiments, the step of maintaining conditions is accomplished by avoiding conditions that: prevent formation of a uniform density bulk form; or give rise to stresses that promote cracking; or promote voids or inclusions.

Different embodiments of inventions disclosed herein use different combinations of elements to form the metal glass. The plated elements may include the following combinations, and also other combinations: Nickel (Ni) and Tungsten (W); Iron (Fe) and Molybdenum (Mo); Iron (Fe) and Tungsten (W); Nickel (Ni) and Molybdenum (Mo); Nickel (Ni) and Phosphorous (P); Nickel (Ni), Tungsten (W) and Boron (B); Iron (Fe), Nickel (Ni) and Carbon (C); Iron (Fe), Chromium (Cr), Phosphorous (P) and Carbon (C); Cobalt (Co) and Tungsten (W); Chromium (Cr) and Phosphorous (P); Copper (Cu) and Silver (Ag); Copper (Cu) and Zinc (Zn); Cobalt (Co) and Zinc (Zn).

According to a representative embodiment, the anode may be platinum and the cathode may be copper.

With different embodiments, the step of maintaining my take different forms. For instance, it can be accomplished by maintaining liquid composition by measuring liquid composition regularly and replenishing any material that has been depleted. Or, it can be accomplished by measuring time, and comparing the measured time to a time entry on a previously prepared calibration table that relates time to liquid composition, thereby measuring liquid composition, and replenishing any material that has been depleted.

According to an elegant embodiment, the step of maintaining may comprise providing, in the liquid, one or more soluble anodes that dissolves into the liquid at a rate that maintains the liquid composition.

In accordance with yet another embodiment, conditions are maintained sufficiently regular for at least six hours.

For one embodiment, an aqueous solution of exactly two metal ions can be used. Rather than an aqueous liquid, one can also use alcohol or liquid hydrogen chloride (HCl). It is beneficial that the solution be one whose composition has been specifically chosen to promote formation of metal glass.

For another embodiment, a solution of exactly one metal ion and phosphorous or boron can be used.

Still another embodiment employs, before the step of providing an electric potential, the step of dressing a portion of the cathode with a masking material to which metal will not plate, such that the step of providing an electric potential between the cathode and the anode such that at least two elements plate out of the liquid at the cathode, comprises providing an electric potential between the cathode and the anode such that at least two elements plate out of the liquid at regions of the cathode that are not dressed with the mask material. With a related embodiment, after the step of providing an electric potential between the cathode and the anode such that at least two elements plate out of the liquid at the cathode, to form metal glass at the cathode, one can perform the step of dressing a second portion of the cathode with a masking material to which metal will not plate, such that the step of providing an electric potential between the cathode and the anode such that at least two elements plate out of the liquid at the cathode, comprises providing an electric potential between the cathode and the anode such that at least two elements plate out of the liquid at additional regions of the cathode that are not dressed with said mask material that had been applied with the second step of dressing.

Moreover, additional embodiments of the invention involve the step of removing at least a portion of the cathode after a body is formed that has at least bulk size in three orthogonal directions. The step of removing can be accomplished by any suitable means, including mechanical and chemical.

Different useful embodiments of an invention are had with different useful shaped geometries for the metal glass object, including but not limited to at least a portion of: a golf club head; a racquet head, such as a tennis racquet; a snowboard; a ski; a ski edge; a knife blade cutting edge; and a spring.

Still other embodiments of inventions disclosed herein are objects formed by any of the processes described above.

Yet another embodiment of inventions disclosed herein is an object having an internal core region and a metal glass outer portion having bulk dimensions and a useful shaped geometry, the object having been formed by a process comprising the steps of: providing an apparatus comprising an anode and a cathode, coupled to each other through a power supply, the cathode being of metal and being of a shape suitable as a progenitor shape for a finished object having the useful shaped geometry; and, providing, in contact with the anode and the cathode, a liquid comprising a solution having at least two ions, at least one of which is a metallic ion, the composition being a specific composition that promotes formation of a metal glass body. The embodiment further includes providing an electric potential between the cathode and the anode such that at least two elements plate out of the liquid at the cathode, at least one of which elements is a metal, to form metal glass at the cathode; and maintaining conditions sufficiently regular for a sufficiently long time so that the elements continue to plate at the cathode as a metal glass until a body is formed that has a metal glass covering over the cathode, which covering is at least bulk size in three orthogonal directions and which body has the useful shaped geometry.

A related embodiment is an object formed by a process further comprising the step of removing at least a portion of the cathode after a body is formed that has at least bulk size in three orthogonal directions.

With still another embodiment, an invention is an object having an interior region and a metal glass outer portion having bulk dimensions and a useful shaped geometry, the object comprising: an interior region of a shape suitable as an electroforming progenitor shape for a finished object having the useful shaped geometry; and adjacent at least one surface of said interior region, an electroformed metal glass body comprising at least two elements, at least one of which is a metal, that is at least bulk size in three orthogonal directions and which body has the useful shaped geometry. An important version of this embodiment is an object further comprising, at the interior region, a metal core comprising a metal capable of acting as an electroforming cathode in process in which the at least two elements are plated from a liquid at such a metal cathode.

Different metal glass compositions for an object embodiment are disclosed, of which several important compositions include but are not limited to: Iron (Fe) and Molybdenum (Mo); Iron (Fe) and Tungsten (W); Nickel (Ni) and Molybdenum (Mo); Nickel (Ni) and tungsten (W); Cobalt (Co) and Molybdenum (Mo); Cobalt (Co) and tungsten (W); iron (Fe) and Phosphorous (P); Nickel (Ni) and Phosphorous (P); cobalt (Co) and Phosphorous (P); Nickel (Ni), Tungsten (W) and Boron (B); Iron (Fe), Nickel (Ni) and Carbon (C); Cobalt (Co), Nickel (Ni) and Phosphorous (P); Cobalt (Co) and Tungsten (W).

The metal glass portion of the object can be composed of exactly two or three elements, or even more.

Still more related embodiments of inventions hereof are objects having a bulk metal glass portion that assumes a useful shape, including but not limited to at least a portion of: a golf club head; a racquet head, for instance a tennis or squash racquet head; a snowboard; a ski edge; knife blade cutting edge; and a spring.

Many techniques and aspects of the inventions have been described herein. The person skilled in the art will understand that many of these techniques can be used with other disclosed techniques, even if they have not been specifically described in use together. For instance, any of the methods for maintaining conditions sufficiently regular can be used with appropriate liquids (such as aqueous, alcohol or hydrogen chloride) or any of the combinations of elements. For instance, a dissolving anode can be used with any of the liquids, just to name one. Various combinations of metals and metals and elements have been disclosed, but other combinations not disclosed, or similar to those disclosed are contemplated as part of inventions hereof, if they can be formed into metal glass under the types of regular conditions discussed herein. The liquid metal salt embodiment has been discussed with specific elements, but would work for other liquid salts as well.

This disclosure describes and discloses more than one invention. The inventions are set forth in the claims of this and related documents, not only as filed, but also as developed during prosecution of any patent application based on this disclosure. The inventors intend to claim all of the various inventions to the limits permitted by the prior art, as it is subsequently determined to be. No feature described herein is essential to each invention disclosed herein. Thus, the inventors intend that no features described herein, but not claimed in any particular claim of any patent based on this disclosure, should be incorporated into any such claim.

Some assemblies of hardware, or groups of steps, are referred to herein as an invention. However, this is not an admission that any such assemblies or groups are necessarily patentably distinct inventions, particularly as contemplated by laws and regulations regarding the number of inventions that will be examined in one patent application, or unity of invention. It is intended to be a short way of saying an embodiment of an invention.

An abstract is submitted herewith. It is emphasized that this abstract is being provided to comply with the rule requiring an abstract that will allow examiners and other searchers to quickly ascertain the subject matter of the technical disclosure. It is submitted with the understanding that it will not be used to interpret or limit the scope or meaning of the claims, as promised by the Patent Office's rule.

The foregoing discussion should be understood as illustrative and should not be considered to be limiting in any sense. While the inventions have been particularly shown and described with references to preferred embodiments thereof, it will be understood by those skilled in the art that various changes in form and details may be made therein without departing from the spirit and scope of the inventions as defined by the claims.

The corresponding structures, materials, acts and equivalents of all means or step plus function elements in the claims below are intended to include any structure, material, or acts for performing the functions in combination with other claimed elements as specifically claimed.

What is claimed is:

1. A method for fabricating a metal glass object having bulk dimensions, comprising the steps of:
a. providing an apparatus comprising an anode and a cathode, coupled to each other through a power supply;
b. providing, in contact with the anode and the cathode, a liquid comprising at least two ions, at least one of which is a metallic ion, the liquid being a specific composition that promotes formation of a metal glass body;
c. providing an electric potential between the cathode and the anode such that at least two elements plate out of the liquid at the cathode, at least one of which elements is a metal, to form metal glass at the cathode; and
d. maintaining conditions sufficiently regular for a sufficiently long time so that the elements continue to plate at the cathode as a metal glass until a body is formed that has at least bulk size in three orthogonal directions.

2. The method of claim 1, the object having a useful shaped geometry and the cathode being of metal and of a shape suitable as a progenitor shape for a finished object having the useful shaped geometry, further wherein the step of maintaining conditions comprises maintaining conditions sufficiently regular for a sufficiently long time so that the elements continue to plate at the cathode as a metal glass until a body is formed that has a metal glass covering over the cathode, which covering is at least bulk size in three orthogonal directions and which body has the useful shaped geometry.

3. The method of claim 2, further comprising the step of removing at least a portion of the cathode after a body is formed that has at least bulk size in three orthogonal directions.

4. The method of claim 1, the step of providing an apparatus further comprising providing a vessel, and the step of providing a liquid comprising providing a liquid in the vessel, in which the anode and the cathode also reside.

5. The method of claim 1, the liquid comprising an aqueous solution.

6. The method of claim 1, the liquid comprising at least one molten salt.

7. The method of claim 1, the liquid comprising at least one metal salt.

8. The method of claim 1, the liquid comprising an alcohol.

9. The method of claim 1, the liquid comprising a HCl (hydrogen chloride).

10. The method of claim 1, the step of maintaining conditions comprising maintaining the composition of the liquid sufficiently constant.

11. The method of claim 1, the step of maintaining conditions comprising maintaining the temperature of the liquid sufficiently constant.

12. The method of claim 1, the step of maintaining conditions comprising maintaining the electrical conditions sufficiently regular.

13. The method of claim 12, said step of maintaining the electrical conditions comprising maintaining the current density with a regular amplitude pulse.

14. The method of claim 1, the step of maintaining conditions comprising avoiding conditions that prevent formation of a uniform density bulk form.

15. The method of claim 14, the step of avoiding conditions comprising avoiding conditions that give rise to stresses that promote cracking.

16. The method of claim 1, the step of maintaining conditions comprising avoiding conditions that promote voids.

17. The method of claim 1, the step of maintaining conditions comprising avoiding conditions that promote inclusions.

18. The method of claim 1, the plated elements comprising Nickel (Ni) and Tungsten (W).

19. The method of claim 18, the anode comprising Platinum (Pt).

20. The method of claim 19, the cathode comprising copper (Cu).

21. The method of claim 1, the step of maintaining comprising actively maintaining liquid composition by measuring liquid composition regularly and replenishing any material that has been depleted.

22. The method of claim 1, the step of maintaining comprising measuring time, and comparing the measured time to a time entry on a previously prepared calibration table that relates time to liquid composition, thereby measuring liquid composition, and replenishing any material that has been depleted.

23. The method of claim 1, the step of maintaining comprising providing, in the liquid, a soluble anode that dissolves into the liquid at a rate that maintains the liquid composition.

24. The method of claim 11, the step of maintaining the temperature comprising providing a digitally controlled oil bath in thermal communication with the liquid and using the oil bath to control the temperature of the liquid.

25. The method of claim 11, the step of maintaining the temperature comprising maintaining the temperature within 2 degrees Centigrade above and below a temperature set point.

26. The method of claim 1, the step of maintaining comprising maintaining conditions sufficiently regular for at least six hours.

27. The method of claim 5, the step of providing an aqueous solution comprising providing a liquid consisting essentially of a solution of exactly two metal ions.

28. The method of claim 1, the step of providing a liquid comprising providing a liquid consisting essentially of a solution of a specific composition of exactly one metal ion, and phosphorous (P).

29. The method of claim 1, the step of providing a liquid comprising providing a liquid consisting essentially of a solution of a specific composition of exactly one metal ion, and boron (B).

30. The method of claim 6, the step of providing a liquid comprising providing a liquid consisting essentially of a solution of a specific composition of exactly two metal ions.

31. The method of claim 8, the step of providing a liquid comprising providing a liquid consisting essentially of a solution of a specific composition of exactly two metal ions.

32. The method of claim 9, the step of providing a liquid comprising providing a liquid consisting essentially of a solution of a specific composition of exactly two metal ions.

33. The method of claim 27, the two ions comprising: Iron (Fe) and Molybdenum (Mo).

34. The method of claim 27, the two ions comprising Iron (Fe) and Tungsten (W).

35. The method of claim 27, the two ions comprising Nickel (Ni) and Molybdenum (Mo).

36. The method of claim 1, the two elements comprising Nickel (Ni) and Phosphorous (P).

37. The method of claim 1, the elements comprising Nickel (Ni), Tungsten (W) and Boron (B).

38. The method of claim 1, the step of providing a liquid comprising providing a liquid consisting essentially of a solution of exactly three ions.

39. The method of claim 38, the three ions comprising Iron (Fe), Nickel (Ni) and Carbon (C).

40. The method of claim 1, the step of providing a liquid solution comprising providing a liquid consisting essentially of a solution of exactly the four ions Iron (Fe), Chromium (Cr), Phosphorous (P) and Carbon (C).

41. The method of claim 38, the three ions comprising Cobalt (Co), Nickel (Ni) and Phosphorous (P).

42. The method of claim 27, the two ions comprising Cobalt (Co) and Tungsten (W).

43. The method of claim 1, the two elements comprising Chromium (Cr) and Phosphorous (P).

44. The method of claim 27, the two ions comprising Copper (Cu) and Silver (Ag).

45. The method of claim 27, the two ions comprising Copper (Cu) and Zinc (Zn).

46. The method of claim 30, the two ions comprising Aluminum (Al) and Manganese (Mn).

47. The method of claim 30, the two ions comprising Cobalt (Co) and Zinc (Zn).

48. The method of claim 1, further comprising, before the step of providing an electric potential, the step of dressing a portion of the cathode with a masking material to which metal will not plate, such that said step of providing an electric potential between the cathode and the anode such that at least two elements plate out of the liquid at the cathode, comprises providing an electric potential between the cathode and the anode such that at least two elements plate out of the liquid at regions of the cathode that are not dressed with said mask material.

49. The method of claim 48, further comprising, after the step of providing an electric potential between the cathode and the anode such that at least two elements plate out of the liquid at the cathode, at least one of which elements is a metal, to form metal glass at the cathode, the step of dressing a second portion of the cathode with a masking material to which metal will not plate, such that said step of providing an electric potential between the cathode and the anode such that at least two elements plate out of the liquid at the cathode, comprises providing an electric potential between the cathode and the anode such that at least two elements plate out of the liquid at additional regions of the cathode that are not dressed with said mask material that had been applied with the second step of dressing.

50. The method of claim 1, further comprising the step of removing at least a portion of the cathode after a body is formed that has at least bulk size in three orthogonal directions.

51. The method of claim 50, said step of removing a portion of the cathode comprising removing using a mechanical process.

52. The method of claim 50, said step of removing a portion of the cathode comprising chemically removing the portion of the cathode.

53. The method of claim 2, the useful shaped geometry being the shape of at least a portion of a golf club head.

54. The method of claim 2, the useful shaped geometry being the shape of at least a portion of a racquet head.

55. The method of claim 2, the useful shaped geometry being the shape of at least a portion of a tennis racquet head.

56. The method of claim 2, the useful shaped geometry being the shape of at least a portion of a snowboard.

57. The method of claim 2, the useful shaped geometry being the shape of at least a portion of a ski edge.

58. The method of claim 2, the useful shaped geometry being the shape of at least a portion of a knife blade cutting edge.

59. The method of claim 2, the useful shaped geometry being the shape of at least a portion of a spring.

60. An object comprising a metal glass portion having dimensions of at least one mm in each of three orthogonal directions, said metal glass portion having been formed by a process comprising the steps of:
a. providing an apparatus comprising an anode and a cathode, coupled to each other through a power supply;
b. providing in contact with the anode and the cathode, a liquid solution comprising at least two ions, at least one of which is a metallic ion, the solution being a specific composition that promotes formation of a metal glass body;
c. providing an electric potential between the cathode and the anode such that at least two elements plate out of the liquid at the cathode, at least one of which elements is a metal, to form metal glass at the cathode; and
d. maintaining conditions sufficiently regular for a sufficiently long time so that the elements continue to plate at the cathode as a metal glass until a body is formed that has at least bulk size in three orthogonal directions.

61. The object of claim 60, the object having a useful shaped geometry the metal glass portion having been formed by a process, wherein the step of providing a cathode comprises providing a cathode of metal and of a shape suitable as a progenitor shape for a finished object having the useful shaped geometry, further wherein the step of maintaining conditions comprises maintaining conditions sufficiently regular for a sufficiently long time so that the elements continue to plate at the cathode as a metal glass until a body is formed that has a metal glass covering over the cathode, which covering is at least bulk size in three orthogonal directions and which body has the useful shaped geometry.

62. The object of claim 60, the metal glass portion having been formed by a process whereby, the step of providing an apparatus further comprises providing a vessel, and the step of providing a liquid comprises providing a liquid in the vessel, in which the anode and the cathode also reside.

63. The object of claim 60, said metal glass portion having been formed by a process further wherein the liquid composition comprises an aqueous solution.

64. The object of claim 60, the two ions comprising: Iron (Fe) and Molybdenum (Mo).

65. The object of claim 60, the two ions comprising Iron (Fe) and Tungsten (W).

66. The object of claim 60, the two ions comprising Nickel (Ni) and Molybdenum (Mo).

67. The object of claim 60, the two ions comprising Nickel (Ni) and tungsten (W).

68. The object of claim 60, the two ions comprising Cobalt (Co) and Molybdenum (Mo).

69. The object of claim 60, the two ions comprising Cobalt (Co) and tungsten (W).

70. The object of claim 60, the two ions comprising iron (Fe) and Phosphorous (P).

71. The object of claim 60, the two ions comprising Nickel (Ni) and Phosphorous (P).

72. The object of claim 60, the two ions comprising Cobalt (Co) and Phosphorous (P).

73. The object of claim 60, the metal glass portion having been formed by a process whereby the step of providing a liquid solution comprises providing a liquid consisting essentially of a solution of exactly three ions.

74. The object of claim 73, the three ions comprising Nickel (Ni), Tungsten (W) and Boron (B).

75. The object of claim 74, the three ions comprising Iron (Fe), Nickel (Ni) and Carbon (C).

76. The object of claim 74, the three ions comprising Cobalt (Co), Nickel (Ni) and Phosphorous (P).

77. The object of claim 60, the two ions comprising Cobalt (Co) and Tungsten (W).

78. The object of claim 60, the two ions comprising Cobalt (Co) and Molybdenum (Mo).

79. The object of claim 60, the metal glass portion having been formed by a process where the step of maintaining comprises actively maintaining liquid composition by measuring liquid composition regularly and replenishing any material that has been depleted.

80. The object of claim 60, the metal glass portion having been formed by a process where the step of maintaining comprises measuring time, and comparing the measured time to a time entry on a previously prepared calibration table that relates time to liquid composition, thereby measuring liquid composition, and replenishing any material that has been depleted.

81. The object of claim 60, the metal glass portion having been formed by a process where the step of maintaining comprises providing, in the liquid, a soluble anode that dissolves into the liquid at a rate that maintains the liquid composition.

82. The object of claim 60, the metal glass portion having been formed by a process where the step of maintaining comprises maintaining conditions sufficiently regular for at least six hours.

83. The object of claim 61, the useful shaped geometry being the shape of at least a portion of a golf club head.

84. The method of claim 61, the useful shaped geometry being the shape of at least a portion of a racquet head.

85. The method of claim 61, the useful shaped geometry being the shape of at least a portion of a tennis racquet head.

86. The method of claim 61, the useful shaped geometry being the shape of at least a portion of a snowboard.

87. The method of claim 61, the useful shaped geometry being the shape of at least a portion of a ski edge.

88. The method of claim 61, the useful shaped geometry being the shape of at least a portion of a knife blade cutting edge.

89. The method of claim 61, the useful shaped geometry being the shape of at least a portion of a spring.

90. An object having an internal core region and a metal glass outer portion having bulk dimensions and a useful shaped geometry, said object having been formed by a process comprising the steps of:
a. providing an apparatus comprising an anode and a cathode, coupled to each other through a power supply, the cathode being of metal and being of a shape suitable as a progenitor shape for a finished object having the useful shaped geometry;
b. providing, in contact with the anode and the cathode, a liquid comprising a solution having at least two ions, at least one of which is a metallic ion, the composition being a specific composition that promotes formation of a metal glass body;
c. providing an electric potential between the cathode and the anode such that at least two elements plate out of the liquid at the cathode, at least one of which elements is a metal, to form metal glass at the cathode; and
d. maintaining conditions sufficiently regular for a sufficiently long time so that the elements continue to plate at the cathode as a metal glass until a body is formed that has a metal glass covering over the cathode, which covering is at least bulk size in three orthogonal directions and which body has the useful shaped geometry.

91. The object of claim 90, said process by which the object is formed further comprising the step of removing at least a portion of the cathode after a body is formed that has at least bulk size in three orthogonal directions.

92. An object having an interior region and a metal glass outer portion having bulk dimensions and a useful shaped geometry, said object comprising:
a. an interior region of a shape suitable as an electroforming progenitor shape for a finished object having the useful shaped geometry; and
b. adjacent at least one surface of said interior region, an electroformed metal glass body comprising at least two elements, at least one of which is a metal, that is at least bulk size in three orthogonal directions and which body has the useful shaped geometry.

93. The object of claim 92, further comprising, at said interior region, a metal core comprising a metal capable of acting as an electroforming cathode in process in which the at least two elements are plated from a liquid at such a metal cathode.

94. The object of claim 92, the two elements comprising:
Iron (Fe) and Molybdenum (Mo).

95. The object of claim 92, the two elements comprising Iron (Fe) and Tungsten (W).

96. The object of claim 92, the two elements comprising Nickel (Ni) and Molybdenum (Mo).

97. The object of claim 92, the two elements comprising Nickel (Ni) and tungsten (W).

98. The object of claim 92, the two elements comprising Cobalt (Co) and Molybdenum (Mo).

99. The object of claim 92, the two elements comprising Cobalt (Co) and tungsten (W).

100. The object of claim 92, the two elements comprising iron (Fe) and Phosphorous (P).

101. The object of claim 92, the two elements comprising Nickel (Ni) and Phosphorous (P).

102. The object of claim 92, the two elements comprising cobalt (Co) and Phosphorous (P).

103. The object of claim 92, the metal glass portion consisting essentially of exactly three elements.

104. The object of claim 103, the three elements comprising Nickel (Ni), Tungsten (W) and Boron (B).

105. The object of claim 104, the three elements comprising Iron (Fe), Nickel (Ni) and Carbon (C).

106. The object of claim 103, the three elements comprising Cobalt (Co), Nickel (Ni) and Phosphorous (P).

107. The object of claim 92, the two elements comprising Cobalt (Co) and Tungsten (W).

108. The object of claim 92, said metal glass portion having a useful shaped geometry.

109. The object of claim 108, the useful shaped geometry being the shape of at least a portion of a golf club head.

110. The object of claim 108, the useful shaped geometry being the shape of at least a portion of a racquet head.

111. The object of claim 108, the useful shaped geometry being the shape of at least a portion of a tennis racquet head.

112. The object of claim 108, the useful shaped geometry being the shape of at least a portion of a snowboard.

113. The object of claim 108, the useful shaped geometry being the shape of at least a portion of a ski edge.

114. The object of claim 108, the useful shaped geometry being the shape of at least a portion of a knife blade cutting edge.

115. The object of claim 108, the useful shaped geometry being the shape of at least a portion of a spring.
